(19) United States
(12) Patent Application Publication
(10) Pub. No.: US 2006/0147080 A1
(43) Pub. Date: Jul. 6, 2006

(54) Magnetized attachment system for cones and other placement and coupling accessories

(76) Inventors: David A. Wilson, Provo, UT (US); Robert Blake Schmutz, Provo, UT (US); Vern Credille, Springville, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/321,686

(22) Filed: Dec. 29, 2005

Related U.S. Application Data
(60) Provisional application No. 60/640,447, filed on Dec. 31, 2004.

(51) Int. Cl. H04R 1/02

(52) U.S. Cl. 381/386; 381/87

(57) ABSTRACT

An improved speaker mounting device and method of mounting allows mounting devices such as mounting cones to be attached to a speaker cabinet on a variety of different sides of the cabinet and without any mounting mechanism being visible on the cabinet. The mounting cones may be attached to the speaker cabinet with magnets.

### BACKGROUND

1. Related Applications

The present application claims the benefit of U.S. Provisional Patent Application No. 60/640,447, filed Dec. 31, 2004, which is expressly incorporated herein.

2. The Field of the Invention

The present invention relates to loudspeakers. More particularly, the present invention relates to an improved mounting system for speakers and related equipment.

3. State of the Art

It has been shown that the method used to mount or support audio and video equipment can have a significant effect on the performance of the equipment. Frequently, inverted cones are attached to the bottom of the equipment. The large end of the cone is attached to the piece of equipment with the pointed end of the cone extending down from the equipment.

Mounting cones such as these typically increase the performance of the piece of equipment. One theory suggests that the cones transmit vibrations from the piece of equipment into the surface upon which it rests, allowing the equipment to be more stable and to function better. The improvement in performance which may result from using mounting cones has been widely observed.

Typically, when using mounting cones, threaded inserts are placed into the bottom of a piece of equipment. The mounting cones are provided with a threaded rod protruding from the base (large side) of the cone which is threaded into the insert to secure the cone. Once the cones are securely tightened, the piece of equipment is placed as desired for operation.

A disadvantage with the present mounting systems exists for loudspeakers. Often, speakers are designed for mounting in multiple orientations. For example, a speaker may be designed to be mounted vertically as a bookshelf speaker, surround speaker, or smaller speaker. Alternatively, the same speaker may be mounted horizontally as a center channel speaker in a home theater or horizontally on a shelf.

It would be desirable to use mounting cones to mount a speaker in situations such as these. A problem exists, however, in attaching the cones to the speaker. If threaded inserts are placed in the speaker, such as in the bottom face of the speaker, the inserts are visible and unsightly if the speaker is placed on its side. Similarly, if threaded inserts are placed on one or both sides of the speaker, these inserts would be visible when the speaker is placed on another side or on the bottom. It is thus not desirable to place these threaded inserts or similar mounting devices on many sides of the speaker to allow for different mounting orientations because the unused inserts diminish the appearance of the speaker.

Additionally, it is desirable for such mounting cones to be removable, as users often desire to change the mounting location or orientation of the speaker. Thus, permanently attaching the cones with adhesive or the like is unsuitable. Temporary adhesives, such as double sided tape or caulking putty do not work well because they decouple the mounting cone from the speaker, reducing the effectiveness of the cone. Temporary adhesives may also leave behind a residue or otherwise adversely affect the finish of the speaker.

There is thus a need for a removable mounting cone and system of mounting which allows mounting cones to be removably mounted on multiple surfaces of a speaker without reducing the effectiveness of the mounting cone and without damaging the appearance of the speaker.

### SUMMARY OF THE INVENTION

It is an object of the present invention to provide an improved mounting system for speakers and other equipment. It is a further object of the present invention to provide an improved mounting cone or mounting device and method of attachment.

According to aspects of the present invention, mounting cones or mounting devices may be removably attached to multiple surfaces of the speaker. The mounting cones may thus be used to mount the speaker in a variety of different orientations.

According to other aspects of the present invention, the mounting cones may be mounted to the speaker in a manner which does not require threaded inserts or other mounts at any location which would diminish the appearance of the speaker. The mounting cones may be mounted to the speaker using a hidden attachment system, such as magnets or magnets and iron in such a manner that the mounting cones are held in place without the need for threaded inserts.

### BRIEF DESCRIPTION OF THE DRAWINGS

Various embodiments of the present invention are shown and described in reference to the numbered drawings wherein:

FIG. 1 shows a mounting cone known in the prior art;

FIG. 2 shows the bottom of a speaker known in the prior art;

FIG. 3a shows the bottom of a speaker according to the present invention;

FIG. 3b shows the side of a speaker according to the present invention;

FIG. 3c shows a perspective view of a speaker according to the present invention;

FIG. 4 shows a mounting device according to the present invention;

FIG. 5a shows another mounting device of the present invention; and

FIG. 5b shows another mounting device of the present invention.

It will be appreciated that the drawings are illustrative and not limiting of the scope of the invention which is defined by the appended claims. The various embodiments shown accomplish various aspects and objects of the invention, and there is no requirement that any embodiment accomplish each aspect or object of the invention.

### DETAILED DESCRIPTION

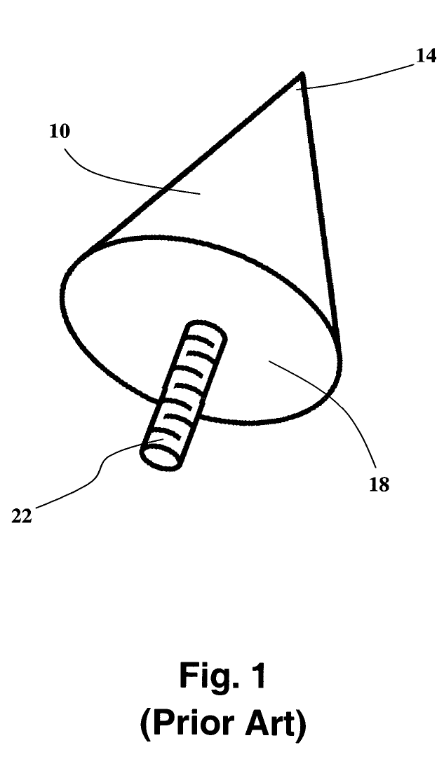

Turning to FIG. 1, a mounting cone known in the prior art is shown. The cone 10 has a pointed end 14 which contacts the surface upon which a speaker is to be placed. The larger flat side 18 of the cone 10 rests against the speaker which the cone is attached to. Typically, mounting cones 10 are provided with a threaded rod 22 which is embedded inside of the cone 10 and used to secure the cone to the speaker.

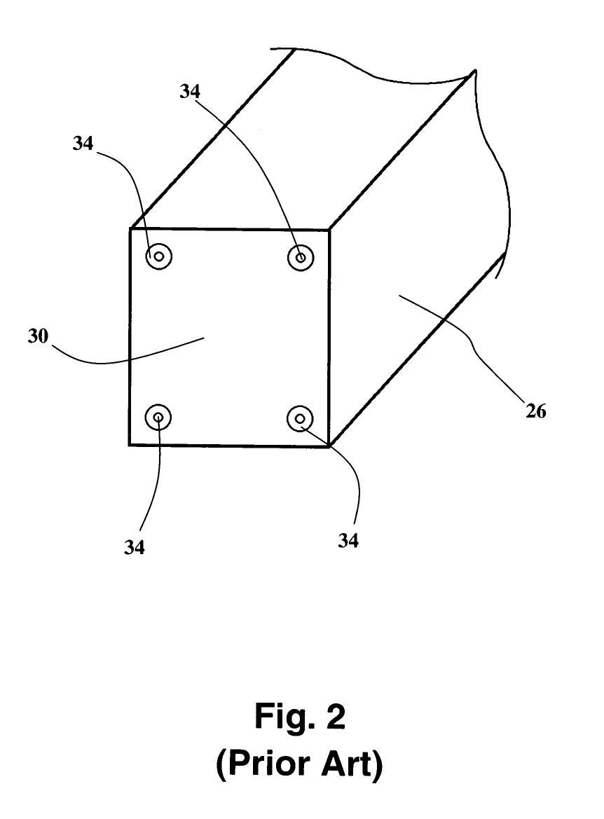

Turning now to FIG. 2, the bottom of a speaker known in the prior art is shown. The speaker 26 is designed to be mounted upright, as is the case for many speakers such as subwoofers, floor standing speakers, or speakers intended for use on a stand. The bottom face 30 of the speaker 26 has four threaded inserts 34. The threaded inserts 34 are designed to receive mounting cones such as that of FIG. 1.

In use, the threaded rods 22 of mounting cones 10 as shown in FIG. 1 are threaded into the threaded inserts 34 of speaker 26. The mounting cones 10 of FIG. 1 and threaded inserts 34 of FIG. 2 are very effective in providing a mounting cone which is rigidly attached to the speaker, providing enhanced performance. It will be appreciated, however, that the threaded inserts 34 are unsightly, and would detract from the appearance of the speaker if placed on any surface of the speaker which is visible. Thus, if a conventional speaker is mounted on its side, two problems exist. One problem is that threaded inserts 34 commonly placed on the bottom of the speaker would be visible. Another problem is that, for aesthetic purposes, threaded inserts 34 or other mounting devices are not typically placed on the side of the speaker, leaving the user without a method of using a mounting cone or other device.

Accordingly, the bottom surface of a typical speaker is typically not finished with the same finish as the sides and top surfaces of the speaker, and threaded inserts are typically placed in the bottom surface. The sides, front, back, and top of a speaker are often finished in a fancy wood veneer or painted finish, and the bottom may be finished in a more simple veneer or black paint. Thus, typically speakers are not typically mounted on their sides, as such an orientation would make visible the less attractive bottom finish and mounting hardware. Thus, a speaker manufacturer may be forced to choose between finishing all sides of a speaker including the bottom for maximum versatility and beauty, or providing a speaker with a less attractive bottom surface including mounting hardware for increased performance.

As previously mentioned, it is desirable to have speakers which may be placed in a variety of mounting locations, and which may use mounting hardware in various different mounting orientations. It would, however, typically be unacceptable to place threaded inserts in multiple sides of the speaker, such as in the base and two sides, as two of these sides would be visible in any mounting configuration.

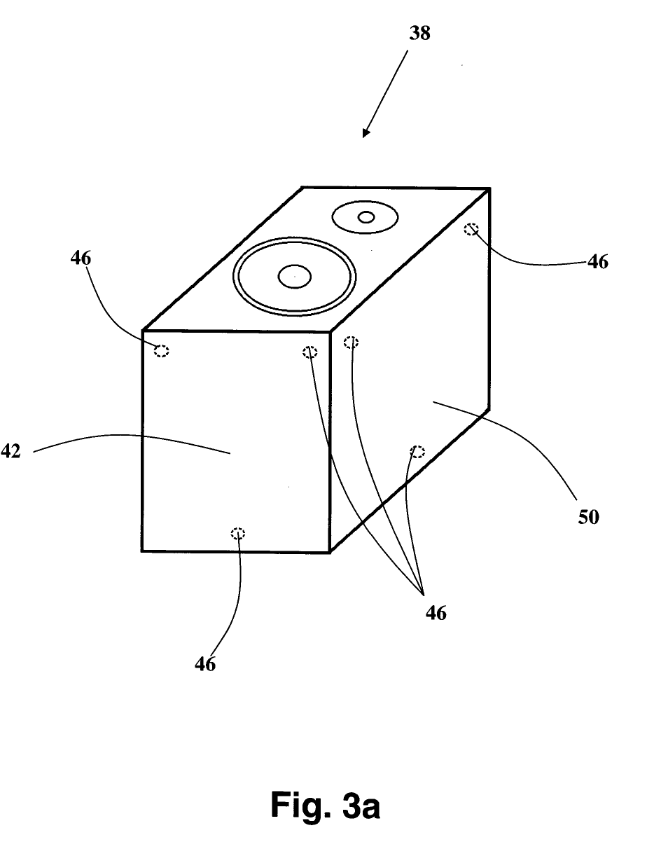

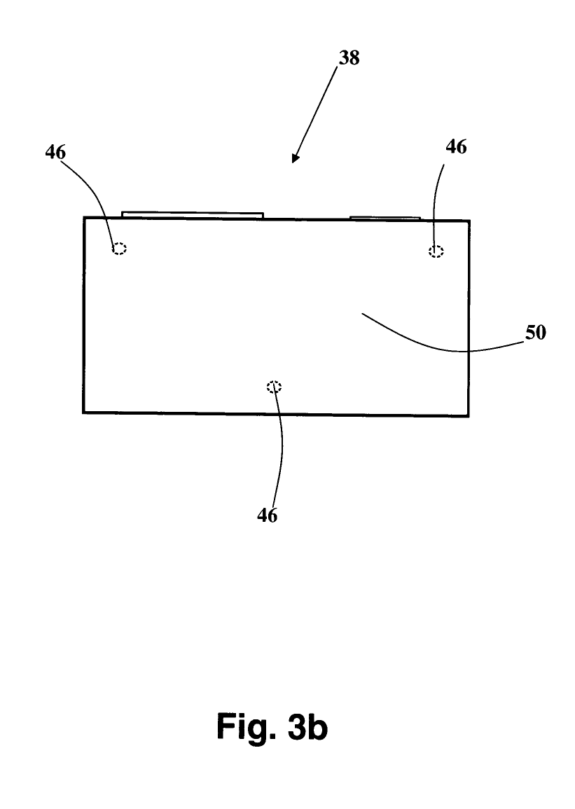

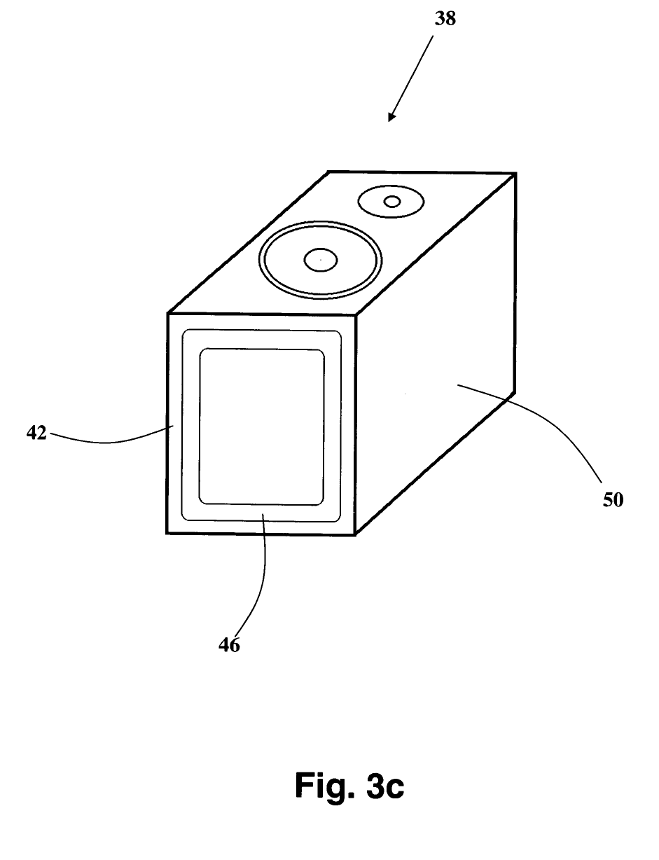

Turning now to FIG. 3a through FIG. 3b, a speaker according to the present invention is shown. FIG. 3a shows a bottom view of the speaker 38. The bottom side 42 of the speaker 38 has multiple mounts 46 (typically three or four) embedded at or below the surface of the speaker. The mounts 46 may be either magnets or a material such as iron which is attracted to magnets. The mounts 46 are placed sufficiently close to the surface of the speaker 38 that the mounts 46 still exert or interact with a magnetic field outside of the speaker 38.

Turning now to FIG. 3b a side view of a speaker is shown. The side 50 of the speaker 38 is provided with mounts 46 embedded below the surface of the speaker similar to mounts 46 of FIG. 3a. The mounts 46 provide a mounting location for mounting cones, but do not affect the surface appearance of the speaker 38. It will be appreciated that the mounts 46 will likely be placed on both sides of the speaker 38, and may be placed on any side of the speaker which is desired. Most commonly, the mounts 46 will be placed on the bottom and sides of the speaker so that the speaker may be mounted vertically or horizontally as desired.

Turning to FIG. 3c, another embodiment of a speaker according to the present invention is shown. The speaker 38 has been formed with a single mount 46 in the base 42 of the speaker. The mount 46 may be formed of a magnet or from iron or another magnetically interactive material, and may be many shapes such as a ring, circle, rectangle, etc. A user may then attach mounting devices such as the mounting devices discussed below to the speaker via mount 46. Such a mount 46 may be disposed in any of the surfaces of the speaker cabinet as is desired, such as in a side 50 of the speaker 38.

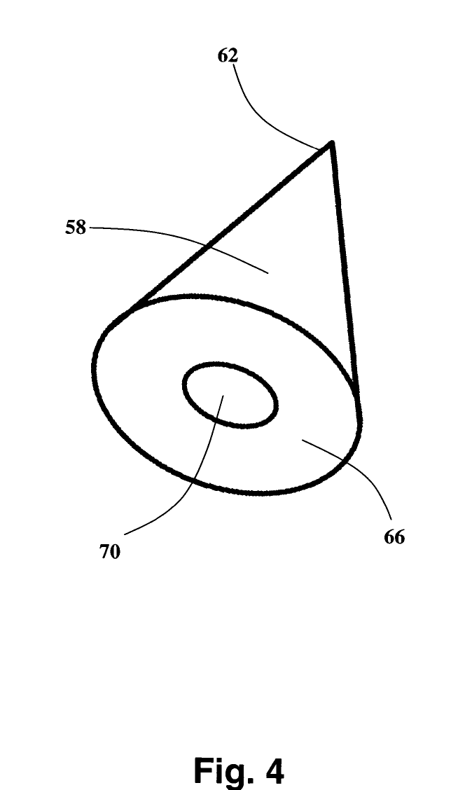

Turning now to FIG. 4, a mounting cone according to the present invention is shown. The mounting cone 58 may be shaped similar to a conventional mounting cone, having a point 62 which will contact the surface upon which the speaker rests and a flat base 66 which contacts the speaker. The cone 58, however, lacks a threaded rod protruding from the base 66 of the cone. Rather, the cone has a mount 70 which is embedded in the base 66 of the cone 58. The mount 70 may be mounted flush with the surface of the base 66, or just below the surface of the base 66. The mount 70 may be a magnet or material which interacts with a magnet such as iron.

As used herein the term “cone” refers broadly to indicate the mounting devices as discussed, and may include a variety of shapes of mounting devices. The mounting cones may have a circular base, a square base, or any number of different shapes. The mounting cones may thus be pyramid shaped, hemisphere shapes, circular cones, etc. What is important is that a sufficiently large flat side exists for holding the cone to the speaker, and that a suitable contact point exists for contacting the surface on which the speaker is placed.

The mount 70 in each of the mounting cones 58 is designed to interact with the embedded mounts 46 in a speaker 38. Thus, if magnets are used as mounts 46 in the speaker 38, the mounts 70 in the cones 58 may be magnets which are positioned to be attracted to the speaker mounts and hold the cone securely to the speaker. Alternatively, the cones 58 may also have an iron button embedded in them as a mount 70, or they may simply be made from a material which is attracted to a magnet.

If the speaker 38 has a button of iron or another material which interacts with a magnet as a mount 46, the mounting cone 58 would have magnets as mounts 70 to hold the mounting cone against the speaker. Thus, one of skill in the art will appreciate that a variety of magnetic materials and materials attracted to a magnet such as iron may be used in combination as is desired, depending on concerns such as cost, magnetic side interactions, desired attachment force, etc. It will be appreciated that the size and type of magnet will be chosen to hold the mounting cone firmly against the speaker cabinet, but allow a user to remove the mounting cone without too much difficulty. Magnets, such as rare earth magnets, exist which are sufficiently strong to hold a mounting cone firmly against the speaker cabinet.

By using magnets to hold the mounting cones to the speaker, the mounting cones are held securely to the speaker. The hard surface of the mounting cone is held against the hard surface of the speaker cabinet which prevents the mounting cone from being decoupled from the cabinet and thus losing its effectiveness, as may be the case with temporary adhesives. Additionally, the use of magnets does not inconvenience a user as temporary adhesives do. Temporary adhesives require cleaning or removal of the adhesive if the mounting orientation is to be changed. Temporary adhesives may also damage the finish.

The mounting cones 58 are held to the speaker 38 with a magnetic mounting system as discussed above allow a user to mount a speaker in any variety of orientations without having unsightly threaded inserts in various sides of the cabinet. Each side of the cabinet may be finished with the desired surface and the appearance of the speaker may be uninterrupted by attachment points for mounting cones. Additionally, the user may quickly and easily change the mounting orientation without seeking additional parts.

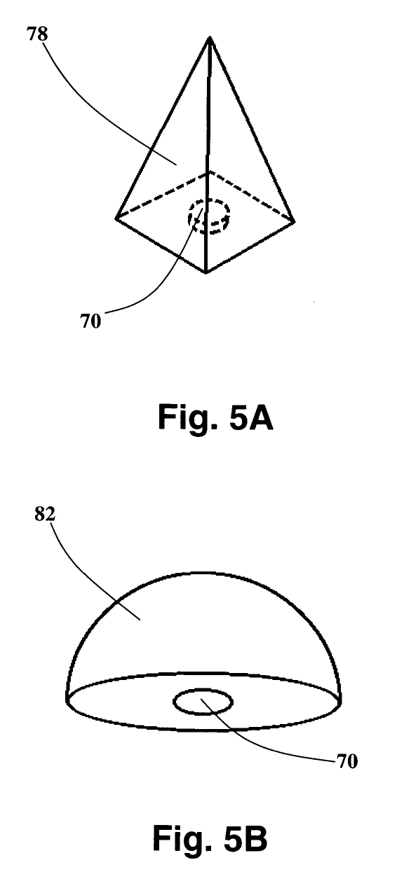

Turning now to FIG. 5A and FIG. 5B, additional shapes for mounting cones are shown. A square based pyramid 78 and a hemisphere 82 with mounts 70 are shown. It will be appreciated that many shapes of mounting cones may be used for aesthetic or performance purposes.

There is thus disclosed an improved speaker mounting cone and method of use. It will be appreciated that numerous modifications may be made to the present invention without departing from the scope of the appended claims.

What is claimed is:

1. A method of mounting speakers comprising:
selecting a speaker having a cabinet;
disposing at least one mount in the speaker cabinet, the mount being selected from the group consisting of magnets and materials attracted to magnets;
providing a plurality of speaker mounting devices having mounts disposed therein so as to allow the speaker mounting devices to be attached magnetically to the speaker cabinet so as to support the weight of the speaker, the mounts being selected from the group consisting of magnets and materials attracted to magnets.

2. The method of claim 1, wherein the method further comprises disposing the at least one speaker cabinet mount below the surface of the speaker cabinet such that they are not visible outside the speaker.

3. The method of claim 1, wherein the method further comprises disposing magnets in both the speaker cabinet and the speaker mounting devices.

4. The method of claim 1, wherein one of the speaker cabinet and mounting devices contains magnets and the other of the speaker cabinet and mounting devices contains a material which is attracted to the magnets.

5. The method of claim 1, wherein the method further comprises disposing mounts in multiple sides of the speaker cabinet so as to allow the speaker mounting devices to be placed on multiple sides of the speaker cabinet.

6. The method of claim 1, wherein the speaker cabinet comprises a base and two sides, and wherein the method further comprises disposing mounts in the bottom and the two sides of the speaker cabinet.

7. The method of claim 1, wherein the speaker mounting devices comprise a first side having a flat surface with a mount disposed therein and configured for magnetic attachment to the speaker cabinet and a second side opposite the first side having minimal surface area and configured for contacting the surface on which the speaker is placed.

8. The method of claim 7, wherein the mounting devices are cone shaped.

9. The method of claim 1, wherein the speaker mounting devices are formed from a material which is attracted to magnets such that the mount is integral to the mounting device.

10. The method of claim 1, wherein the method comprises magnetically attaching the plurality of speaker mounting devices to the base of the speaker cabinet and placing the speaker upright on a surface.

11. The method of claim 1, wherein the method comprises magnetically attaching the plurality of speaker mounting devices to a side of the speaker cabinet and placing the speaker on a surface with said side facing down.

12. A speaker comprising:
a speaker cabinet;
at least one mount disposed in the speaker cabinet configured for magnetically engaging a plurality of speaker mounting devices.

13. The speaker of claim 12 wherein the at least one mount is disposed below the surface of the speaker cabinet.

14. The speaker of claim 12, wherein the speaker comprises a plurality of mounts disposed on multiple sides of the speaker cabinet.

15. The speaker of claim 12, wherein the at least one mount is a magnet.

16. The speaker of claim 12, wherein the at least one mounts is formed from a material which is attracted to magnets.

17. The speaker of claim 12 wherein speaker comprises a plurality of mounts disposed in the base and two sides of the speaker cabinet.

18. A system comprising the speaker of claim 12 and further comprising a plurality of speaker mounting devices configured for magnetic attachment to the speaker cabinet.

19. The system of claim 18, wherein the speaker mounting devices comprise at least one flat surface for attachment to the speaker cabinet and at least one pointed surface for contacting the surface on which the speaker is to be placed.

20. The system of claim 18, wherein the speaker mounting devices are formed from a material attracted to magnets and wherein the mounts disposed in the speaker are magnets.

21. The system of claim 18, wherein the speaker mounting cones comprise mounts selected from the group consisting of magnets and material attracted to magnets.

22. A mounting device for attachment to a speaker cabinet comprising:
a flat surface for contacting the speaker cabinet;
a pointed end disposed generally opposite the flat surface;
a mount disposed in the flat surface which is selected from the group consisting of a magnet and a material attracted to magnets.

23. The mounting device of claim 22, wherein the mount is a magnet.

24. The mounting device of claim 22, wherein the mounting device is attached to a speaker solely by magnetic attraction.

25. The mounting device of claim 22, wherein the device lacks any protrusion for physically engaging the speaker.

26. A system comprising the mounting device of claim 22, and comprising a speaker cabinet comprising at least one mount disposed therein, the at least one mount being selected from the group consisting of magnets and material attracted to magnets.
